(19) United States
(12) Patent Application Publication
(10) Pub. No.: US 2016/0113046 A1
(43) Pub. Date: Apr. 21, 2016

(54) System and Method for Reducing Communications Overhead

(71) Applicant: Futurewei Technologies, Inc., Plano, TX (US)

(72) Inventors: Hanan Ahmed, Belleville, MI (US); George Calcev, Hoffman Estates, IL (US); Bin Chen, Schaumburg, IL (US)

(21) Appl. No.: 14/517,607

(22) Filed: Oct. 17, 2014

(51) Int. Cl. H04W 76/02; H04W 36/30

(52) U.S. Cl. CPC H04W 76/021; H04W 36/30

(57) ABSTRACT

A method for operating a requesting station includes generating a generic advertising service (GAS) request message including device class information, and transmitting the GAS request message. The method also includes receiving a GAS response message from a responding station, where the GAS response message includes information responsive to the device class information.

### TECHNICAL FIELD

The present disclosure relates generally to digital communications, and more particularly to a system and method for reducing communications overhead.

### BACKGROUND

Obtaining information from a device(s) is very useful in helping to reduce communications overhead. The information helps to eliminate unsuitable devices from consideration, which can prevent associating or communicating with the unsuitable devices. The information also helps to select suitable devices to consider, which can help hasten associating or communicating processes.

In the present standards specifications IEEE 802.11Revmb Draft 12 and Wi-Fi Alliance (WFA) Hotspot 2.0 (HS2.0) Rel2, a station can request access network query protocol (ANQP) information (attributes) from an access point (AP) before or after association. The requested attributes may be listed in a single query or using subsequent queries. The requests/response and comeback sequence may become unnecessarily lengthy and may be delayed due to the over the air channel contention, the communication overhead and the latency.

A station also can request the Neighbor Report from the associated AP to support fast transition. This information is specific to fast transition procedure and not for network discovery and selection. In the Hotspot 2.0 specification as well as the 802.11u amendment for the ANQP specifics of network discovery and selection, there is no way to query about only APs satisfying a certain condition.

Furthermore, the IEEE 802.11Revmb Draft 12 and WFA HS2.0 Rel2 standards allow compliant devices to query for specific information, and then make a decision based on their capability. User devices may differ in their screen size, processing capability, resolution, supported features or technologies, and the like, and thus in the ability to effectively support certain applications. As an example, in the current WiFi HS 2.0 standards, as part of the network discovery and selection, a device requests an Online Sign Up (OSU) provider icon of the requested size in pixels using the “Icon Request” HS2.0 ANQP element.

Additionally, the WFA HS2.0 Rel2 standards allow for exchanging ANQP elements between an AP and a mobile device or station (STA) before association using media access control (MAC) messages as defined in the IEEE 802.11u specification. This exchange allows the mobile device to query for network information before association. The obtained information is useful in helping the mobile device determine to which network it will connect. The mobile device may query several APs before it selects an AP for association. Examples of elements are “Network Authentication Type,” “NAI Realm,” “AP Geospatial Location,” and the like.

### SUMMARY OF THE DISCLOSURE

Example embodiments of the present disclosure which provide a system and method for reducing communications overhead.

In accordance with an example embodiment of the present disclosure, a method for operating a requesting station is provided. The method includes generating, by the requesting station, a generic advertising service (GAS) request message including device class information, and transmitting, by the requesting station, the GAS request message. The method also includes receiving, by the requesting station, a GAS response message from a responding station, where the GAS response message includes information responsive to the device class information.

In accordance with another example embodiment of the present disclosure, a method for operating a responding station is provided. The method includes receiving, by the responding station, a generic advertising service (GAS) request message including device class information, and generating, by the responding station, a GAS response message including information responsive to the device class information. The method also includes transmitting, by the responding station, the GAS response message.

In accordance with another example embodiment of the present disclosure, a requesting station is provided. The requesting station includes a processor, a transmitter operatively coupled to the processor, and a receiver operatively coupled to the processor. The processor generates a generic advertising service (GAS) request message including device class information. The transmitter transmits the GAS request message. The receiver receives a GAS response message from a responding station, where the GAS response message includes information responsive to the device class information.

In accordance with another example embodiment of the present disclosure, a responding station is provided. The responding station includes a receiver, a processor operatively coupled to the receiver, and a transmitter operatively coupled to the processor. The receiver receives a generic advertising service (GAS) request message including device class information. The processor generates a GAS response message including information responsive to the device class information. The transmitter transmits the GAS response message.

One advantage of an embodiment is that the use of a query that is configured to reduce communications overhead helps to improve overall communications system performance by freeing up communications system resources otherwise dedicated to information query.

A further advantage of an embodiment is that extensions to device classes help to reduce communications overhead by enable communications with devices in accordance with their belonging or not belonging to device classes.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2 illustrates an example GAS message exchange sequence with dot11GASPauseForServerResponse equal to true according to example embodiments described herein;

FIG. 3 illustrates an example GAS message exchange sequence using Comeback requests/responses according to example embodiments described herein;

FIG. 4 illustrates an ANQP usage table;

FIG. 5 illustrates a Capability List ANQP-element format;

FIG. 6 illustrates an ANQP element format;

FIGS. 7a-7b illustrate ANQP-element definitions;

FIG. 8 illustrates advertisement protocol ID definitions;

FIG. 9a illustrates a flow diagram of example operations occurring in a requesting device as the responding device requests information utilizing device class information according to example embodiments described herein;

FIG. 9b illustrates a flow diagram of example operations occurring in a responding device as the responding device responds to a request including device class information according to example embodiments described herein;

FIG. 10a illustrates a flow diagram of example operations occurring in a requesting device as the requesting device requests information using a request with an attribute class according to example embodiments described herein;

FIG. 10b illustrates a flow diagram of example operations occurring in a responding device as the responding device responds to a request message with an attribute class according to example embodiments described herein;

FIG. 11a illustrates a flow diagram of example operations occurring in a requesting device as the requesting device requests information using a request with a device capability and/or mobility class according to example embodiments described herein;

FIG. 11b illustrates a flow diagram of example operations occurring in a responding device as the responding device responds to a message with a device capability and/or mobility class according to example embodiments described herein;

FIG. 12a illustrates a flow diagram of example operations occurring in a requesting device as the requesting device requests information about a service according to example embodiments described herein;

FIG. 12b illustrates a flow diagram of example operations occurring in a responding device as the responding device responds to a message with a request for a service according to example embodiments described herein; and

FIG. 13 illustrates an example communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to reducing communications overhead. For example, a requesting station generates a generic advertising service (GAS) request message including device class information, and transmits the GAS request message. The requesting station also receives a GAS response message from a responding station, where the GAS response message includes information responsive to the device class information.

The present disclosure will be described with respect to example embodiments in a specific context, namely communications systems that support classes and/or queries to reduce communications overhead. The disclosure may be applied to standards compliant communications systems, such as those that are compliant with Third Generation Partnership Project (3GPP), IEEE 802.11, WiMAX, Wi-FI, and the like, technical standards, and non-standards compliant communications systems, that support classes and/or queries to reduce communications overhead.

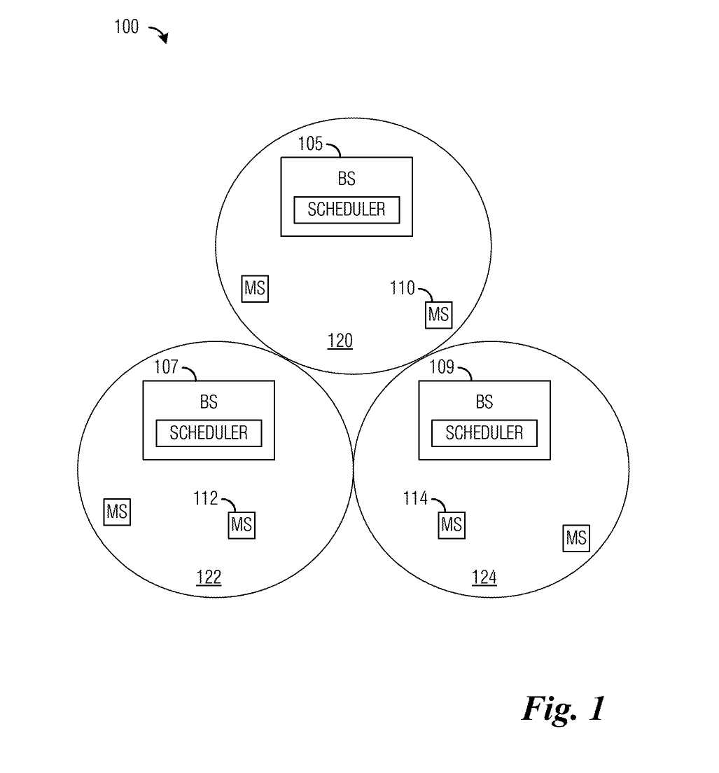

FIG. 1 illustrates an example communications system 100. Communications system 100 includes a plurality of base stations (BSs), such as BS 105, BS 107, and BS 109. The BSs may also be referred by other names, such as access points (AP), access networks (AN), NodeBs, evolved NodeBs (eNB), and the like. The BSs may transmit downlink (DL) information to mobile stations (MSs), such as MS 110, MS 112, and MS 114, while receiving uplink (UL) information from the MSs. The MSs may also be referred by other names, such as mobiles, terminals, users, subscribers, user equipments (UE), and the like.

While it is understood that communications systems may employ multiple BSs capable of communicating with a number of MSs, only three BSs, and a number of MSs are illustrated for simplicity.

Each BS has a corresponding coverage area. As an illustrative example, BS 105 has a coverage area 120, BS 107 has a coverage area 122, and BS 109 has a coverage area 124. The coverage areas represent the range of each BS to adequately transmit data. While not necessarily shown, the coverage area of adjacent BSs may have some overlap in order to accommodate handoffs (HOs) between BSs when a MS exits a first coverage area and enters an adjacent second coverage area. The BSs may include schedulers for allocating communications system resources to the MSs that they are serving.

In IEEE 802.11REVmb D12, section 10.24.3 describes interworking procedures with generic advertisement service (GAS). GAS provides transport mechanisms for advertisement services while STAs are in the unassociated state as well as the associated state. This is accomplished via the use of Public Action management frames, which are Class-1 frames. GAS messages are transmitted using individually-addressed Public Action frames. When management frame protection is negotiated, stations use individually addressed Protected Dual of Public Action frames instead of individually addressed Public Action frames.

Section 10.24.3.1 describes the GAS protocol. The presence of the Interworking element in Beacon or Probe Response frames indicates support for the GAS protocol. The presence of the Advertisement Protocol element in Beacon or Probe Response frames indicates the Advertisement Protocol IDs supported in the basic service set (BSS) or independent BSS (IBSS). A STA transmits a GAS Query Request in a GAS Initial Request frame and the responding STA provides the GAS Query Response or information on how to receive the GAS Query Response in a GAS Initial Response frame. The GAS Query Response is delivered in a single GAS Initial Response frame or in one or more GAS Comeback Response frames. The GAS Query Response is not split between a GAS Initial Response frame and one or more GAS Comeback Response frames.

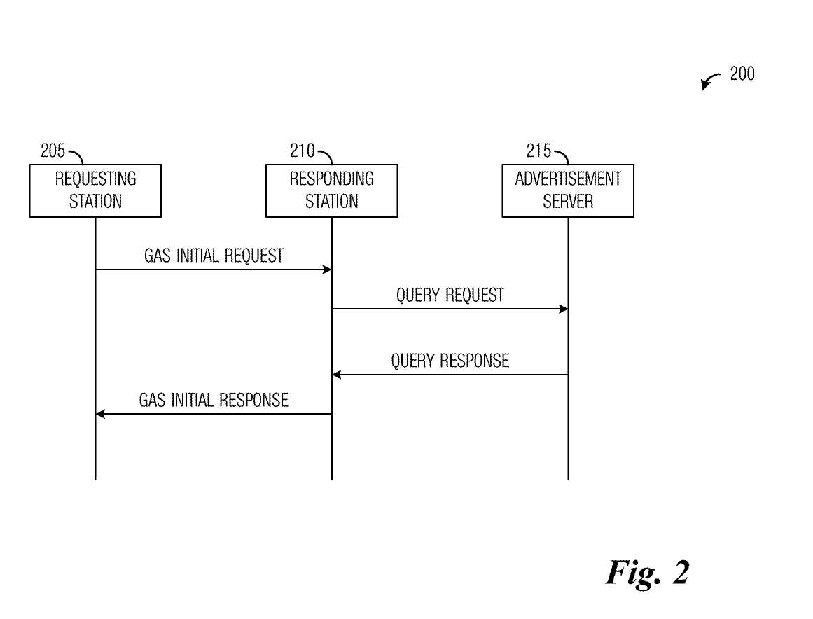

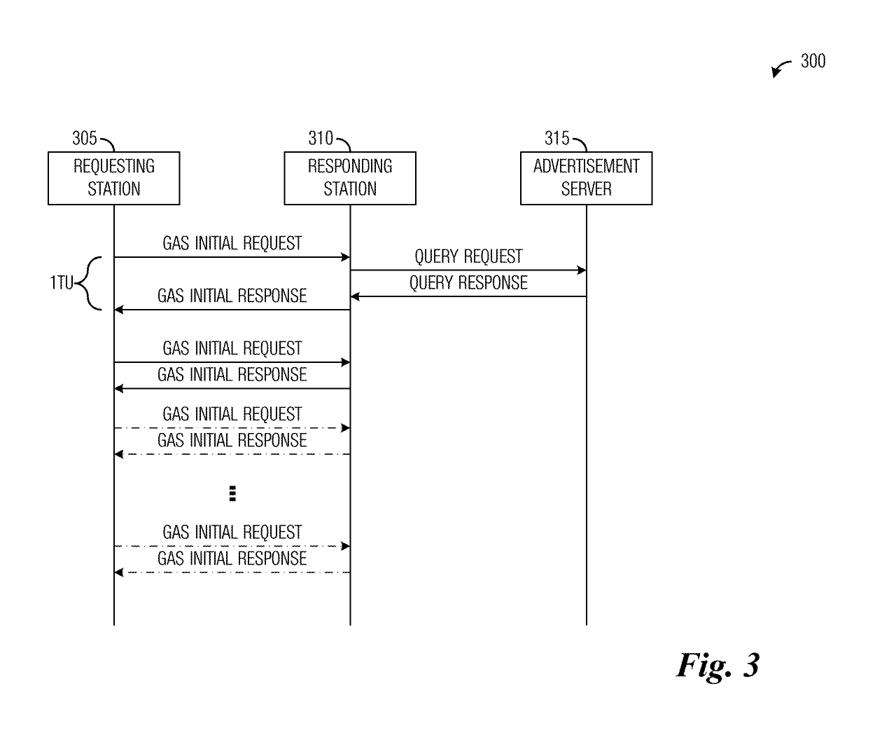

FIG. 2 illustrates an example GAS message exchange sequence 200 with dot11GASPauseForServerResponse equal to true. GAS message sequence 200 involves messages exchanged between a requesting station 205, a responding station 210, and an advertisement server 215. FIG. 3 illustrates an example GAS message exchange sequence 300 using Comeback requests/responses. GAS message sequence 300 involves messages exchanged between a requesting station 305, a responding station 310, and an advertisement server 315.

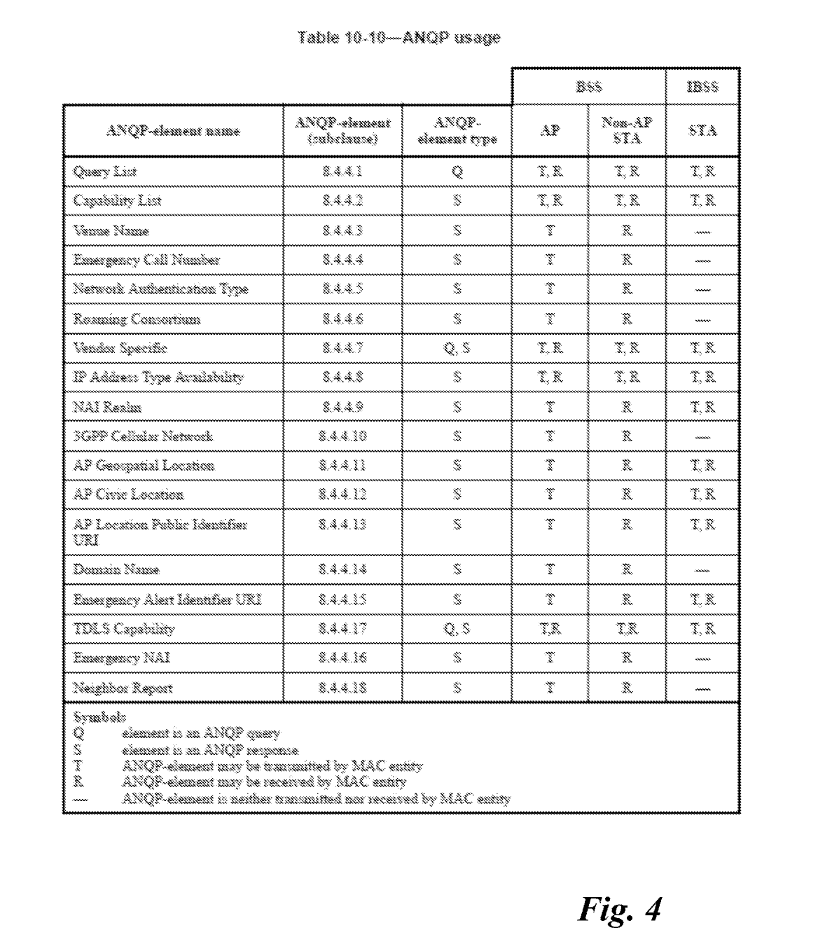

Section 10.24.3.2.2 describes the Query List procedure. The Query List ANQP-element is used by a requesting STA to perform an ANQP Query using the procedures defined in 10.24.3.2.1. The requesting STA only includes Info IDs in the Query List ANQP element that have the sole ANQP-element type of S as shown in Table 10-10, which is shown in FIG. 4. Info IDs that have an ANQP element type of Q are not included in the Query List ANQP-element (e.g., the Info ID for Vendor Specific ANQP-element is not included). A responding STA that encounters an unknown or reserved ANQP Info ID value in an ANQP Query list received without error ignores that ANQP Info ID and parses any remaining ANQP Info IDs.

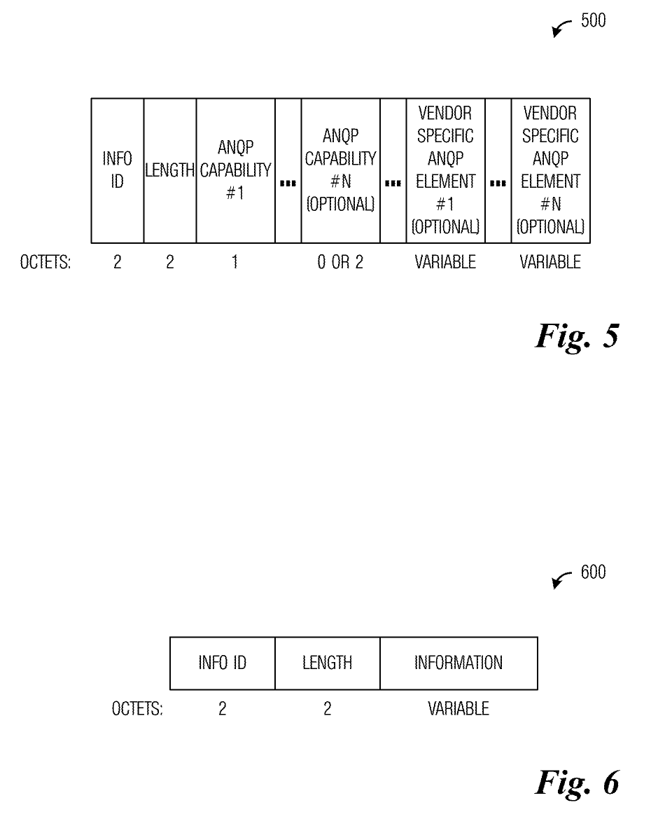

Section 8.4.4.2 describes the Capability List ANQP-element. The Capability List ANQP-element provides a list of information/capabilities that has been configured on a STA. The Capability List ANQP-element is returned in response to Query List ANQP-element containing the Info ID of the Capability List ANQP-element. FIG. 5 illustrates the Capability List ANQP-element format 500.

Section 8.4.4 describes ANQP elements. ANQP-elements are defined to have a common format consisting of a 2-octet Information Identifier (Info ID) field, a 2-octet length field, and a variable-length element-specific information field. Each element is assigned a unique Info ID as defined in the standard. FIG. 6 illustrates the ANQP-element format 600.

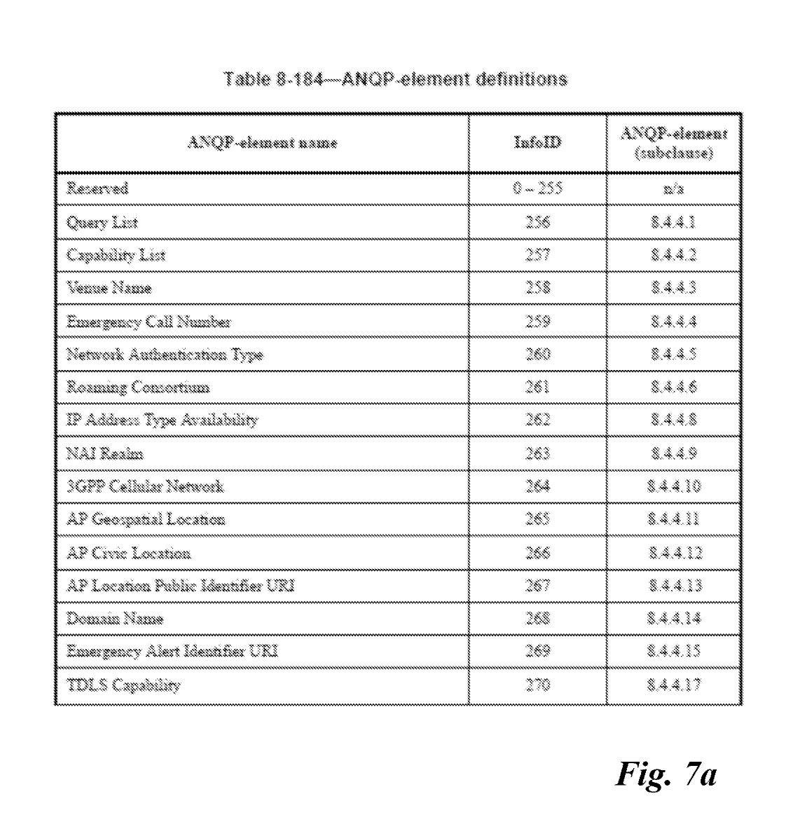

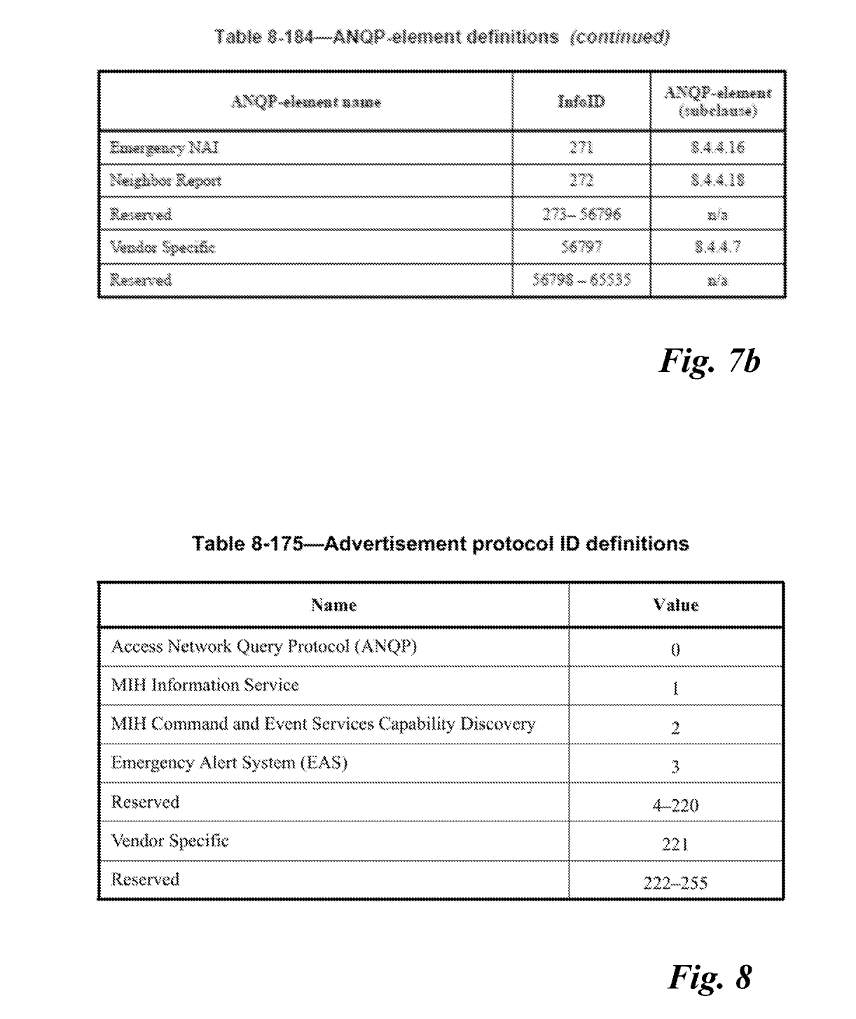

The ANQP-elements that may be configured are listed in Table 8-184 as shown in FIGS. 7a-7b. If information is not configured for a particular ANQP-element, then a query for that element returns that element with all optional fields not present.

FIG. 8 illustrates advertisement protocol ID definitions from IEEE 802.11REVmb_D12.0.

Generally, parameters are individually listed. APs are queried individually or an AP can be queried about its neighbors. A mobile device cannot group requested ANQP information related to certain operations. It also cannot screen the requested APs based on a specific criterion. There is not a way to limit the query to APs that satisfy a certain condition (e.g., support a functionality or a service). Enabling the device to query an AP or about APs that match a certain criteria (i.e., part of a class) can reduce the over the air channel contention, the communication overhead and the latency for network discovery and selection.

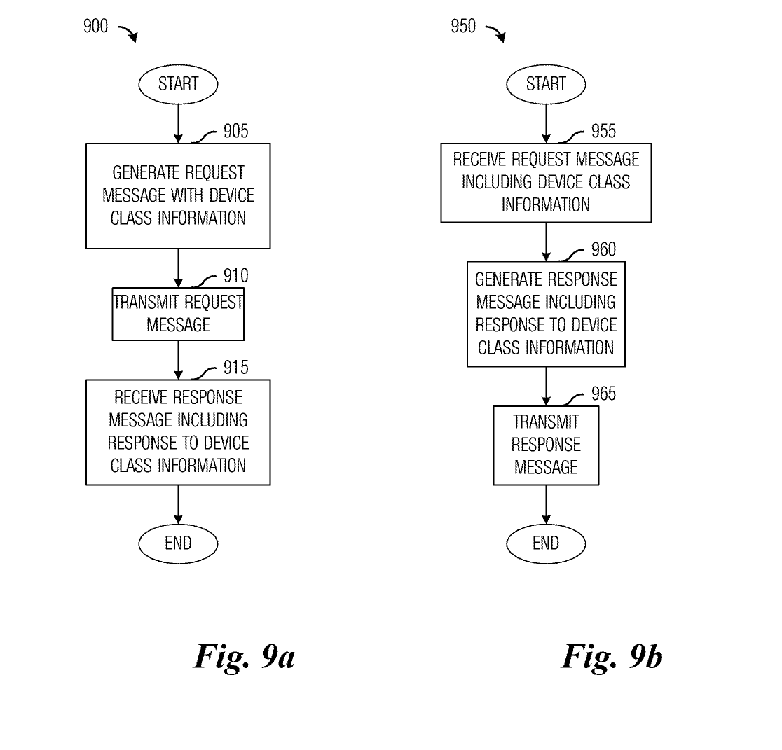

FIG. 9a illustrates a flow diagram of example operations 900 occurring in a requesting device as the responding device requests information utilizing device class information. Operations 900 may be indicative of operations occurring in a requesting device, such as requesting station 205 and requesting station 305, as the requesting device requests information utilizing device class information.

Operations 900 may begin with the requesting device generating a request message with device class information (block 905). The device class information may be included in a request in the request message. Examples of device class information may include attribute class information, device capability class information, device mobility class information, service class information, and the like. As an example, the request message may be a GAS request message. The requesting device may transmit the request message (block 910). The requesting device may receive a response message including a response to the device class information (block 915). The response may include information, such as ANQP information, responsive to the device class information included in the request message. As an example, the response message may be a GAS response message from a responding device.

FIG. 9b illustrates a flow diagram of example operations 950 occurring in a responding device as the responding device responds to a request including device class information. Operations 950 may be indicative of operations occurring in a responding device, such as responding station 210 and responding station 310, as the responding device responds to a request that includes device class information.

Operations 950 may begin with the responding device receiving a request message with device class information (block 955). The device class information may be included in a request included in the request message. Examples of device class information may include attribute class information, device capability class information, device mobility class information, service class information, and the like. If the responding device has information responsive to the request, the responding device may generate a response message including the information (block 960). Alternatively, the responding device may query its neighbor devices or servers, such as an advertisement server, for information responsive to the request. The responding device may generate a response message including information that it receives from neighbor devices or servers. The responding device may transmit the response message (block 965).

According to an example embodiment, a device queries about parameters that are grouped together in a class. A defined class is typically associated with the most common actions and the related parameters. An embodiment enables the device to query an AP or about APs that match a certain criteria (i.e., part of a class) to reduce over the air channel contention, the communication overhead and the latency for network discovery and selection. An embodiment provides a new extension of the original GAS and ANQP protocol proposed in 802.11u to allow a STA to send GAS requests to an AP asking for the ANQP Class of attributes, and to query information pertaining to APs that satisfy a condition.

An example embodiment method provides an ANQP query about other APs, such as neighboring APs. In an example embodiment a station (a requesting device) combines various ANQP attributes and their expected values via logical operators in a single query. A receiving AP (a responding device) replies to this query with a list of neighboring AP satisfying the logical condition. An example embodiment provides the ability to filter the requested APs based on criteria, instead of repeatedly querying APs and then later discovering the lack of needed capabilities. An example embodiment provides shorter queries, potentially less messages and delays, and more efficient and targeted queries for network selection. Example embodiments may be applied to Wi-Fi stations and servers, WiFi mobile devices supporting hotspot 2.0, and ANQP servers.

In the present standards specifications, such as IEEE 802.11Revmb Draft 12 and WFA HS2.0 Rel2, a station can request ANQP information from an AP before or after association. The requested attributes may be listed in a single query or using subsequent queries. The requests and/or response and associated comeback sequence may become unnecessarily lengthy and may be delayed since comebacks are carried in separate messages.

According to an example embodiment, the attributes are grouped into classes. The classes may overlap and typically are associated with an intended action or procedure. Requests may be extended to include the class/combination of classes of requested parameters. Reserved elements may be used in defining the new classes that typically are associated with commonly used actions. An example of a class is “Initial association,” and a combination of classes may be “HO” with “Video”, where HO is handover; it also can be combined with quality of service (QoS) classes.

An example embodiment provides a new extension of the original GAS and ANQP protocol proposed in 802.11u to allow a STA to send GAS requests to an AP asking for the ANQP Class of attributes (information) specific to that AP. An example of a class of attributes is “initial association,” which can be queried to an AP that may return attributes that can be used to evaluate the AP for association. The same query may be made to an AP to query the “initial association” class of attributes about other APs, typically neighboring ones. Combined classes may be used to narrow down the criteria for selection.

A “Subtype” is defined to identify the requested attribute class. In case the requesting device is able to query about other APs from the target AP (i.e., an AP that is being queried), and where multiple APs share a common criteria that may be relevant to a specific request by the requesting station, there is no way to classify a group of APs based on these characteristics (supported band or services, geography, common SP, etc.) and there is no way to query information about APs belonging to that class only.

An example embodiment defines classes for APs to simplify certain procedures. The classes may be defined based on supported band, available services, geography, common SP, etc.). A station may query using a class of APs to request information pertaining to APs within that class. An AP may advertise its class.

The requesting device may unicast a request (with a class) to AP(s) without knowing their class. If a receiving AP is part of that class or has information pertaining to APs within that class, it may respond with its own information and/or other APs' information within that class. If the AP has no such class information, it may respond with an error message.

This definition provides a tool that is expandable in the future. An advantage of an example embodiment classification is that it cuts overhead and simplifies discovery for association and handover. The information may be stored locally at the AP or obtained through other means.

A “Subtype” is defined to identify the requested AP class. The ANQP attributes are extended to include one or more of “Attribute Class,” “AP Class,” “Service,” and “Location”. Requesting stations may combine Attribute Classes and AP Classes in a query and they may query using single or a combination of “Attribute Class,” “AP Class,” “Service,” and “Location” in one query.

Although ANQP procedures are used for WiFi network discovery and selection, the AP Classes are applicable to other entities such as BSs which can be checked before handover. The above-described methods and structures are applicable to advertisement protocols listed in table 8-175 in IEEE 802.11REVmb_D12.0 (FIG. 8), such as MIH information Service, MIH Command and Event Services Capability Discovery, and Emergency Alarm System.

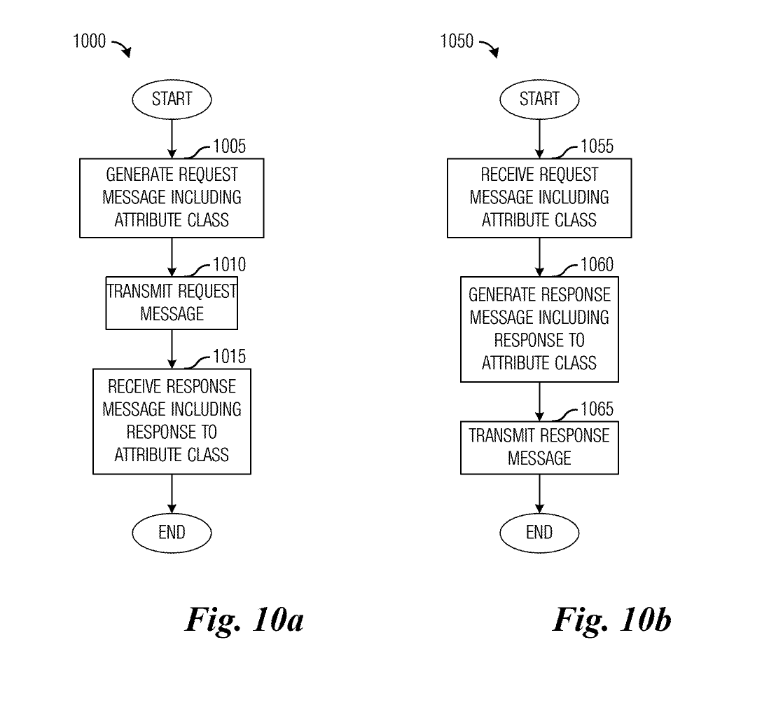

FIG. 10a illustrates a flow diagram of example operations 1000 occurring in a requesting device as the requesting device requests information using a request with an attribute class. Operations 1000 may be indicative of operations occurring in a requesting device, such as a requesting station 205 and requesting station 305, as the requesting device requests information using a request with an attribute class.

Operations 1000 may begin with the requesting device generating a request message including an attribute class(es) (block 1005). The attribute class(es) may include various ANQP attributes and the expected values that are combined by one or more logical operators. The attribute class allows the requesting device to query about parameters that are grouped together to form the attribute class. The attribute classes may overlap and are normally associated with an intended action or procedure, such as “initial association”, “handover”, “video”, “QoS”, and the like.

The request message may also request attribute class information of a specific device. As an illustrative example, the attribute class may be “initial association” and may be sent to an AP, which may return attributes that are used by the requesting device to evaluate the AP for association purposes. A similar query may be made to an AP to query the “initial association” attribute class of other AP, such as neighboring APs of the AP. It may be possible to narrow down the criteria for selection by combining attribute classes.

The attribute class may be defined for APs to simplify procedures. As an illustrative example, attributes may be defined based on supported band, available services, geography, common SP, and the like. A requesting device may query using an attribute class of APs to request information pertaining specifically to APs that belong to the attribute class. The APs may advertise their classes to inform requesting devices of their availability.

The requesting device may transmit the request message (block 1010). The requesting device may broadcast the request message. The requesting device may unicast the request message to specific APs even if the requesting device does not know the class(es) of the APs. The requesting device may receive a response message including information responsive to the attribute class(es) (block 1015). An AP receiving the request message may respond if it is part of the attribute class or it may respond with information of other APs if they belong to the attribute class. If the AP does not have any information (of its own or of other APs), the AP may respond with an error message.

FIG. 10b illustrates a flow diagram of example operations 1050 occurring in a responding device as the responding device responds to a request message with an attribute class. Operations 1050 may be indicative of operations occurring in a responding device, such as a responding station 210 and responding station 310, as the responding device responds to a request message with an attribute class.

Operations 1050 may begin with the responding device receiving a request message including an attribute class(es) (block 1055). The responding device may determine if it meets the attribute class(es). If the responding device does meet the attribute class(es), the responding device may generate a response message including information associated with the attribute class(es) (block 1060). The responding device may query other APs, e.g., its neighbor APs, regarding the attribute class(es) and generate a response message including information received from the other APs (block 1060). The responding device may transmit the response message (block 1065).

According to an example embodiment, a Device Capability Class and/or a Device Mobility Class may be communicated before or after association to the network. The classes may be used to simplify the discovery process and to make intelligent decisions in directing devices to appropriate networks. Knowing the device capability before association may help simplify the network selection. Knowing the device mobility level may help in load balancing, anticipating users' needs and improving user experience, and the like. Example embodiments may be applied to Wi-Fi stations and servers, WiFi mobile devices supporting hotspot 2.0, and ANQP servers.

In the present standards specifications, such as IEEE 802.11Revmb Draft 12 and WFA HS2.0 Rel2, devices have to query for specific information, and then make a decision based on their capability. An example embodiment defines a new parameter for “Device Capability Class” to simplify network selection and to enhance the user experience after connection. The defined class may be based on the screen size, processing capability, resolution, and the like, and provide the ability to effectively support certain applications.

As an illustrative example, in the current WiFi HS 2.0 specification, as part of the network discovery and selection, a device requests an Online Sign Up (OSU) provider icon of the requested size in pixels using the “Icon Request” HS2.0 ANQP element. Defining device classes that reflect the device capability may be used to simplify similar procedures without the need to use separate queries for this information. Having the capability class known may simplify the subsequent requests related to the “IconRequest” and “IconFile”, because some criteria related to the device capability can be identified, and thus the acceptable icon size can be identified. Another example of a “Device Capability Class” is the supported and/or preferred band(s).

In the present standards specifications, such as IEEE 802.11Revmb Draft 12 and WFA HS2.0 Rel2, as well as other air interface and network standards, stations may access a network without considering their level of mobility (i.e., potential for mobility). User devices differ in their size, weight, capability and expected level of mobility, but in current implementations, there is no distinction based on the device mobility level. In an example embodiment, identifying a Device Mobility class may give an indication about the level of mobility of the device accessing the system.

An example embodiment defines a new parameter “Device Mobility Class” for the above-described purpose. In some cases it may not be able to be used strictly, but it can be assumed, for example, that a phone has a higher mobility class than a PC. The information may be used for mobility-related behavior. For example, if the UE tells the server it is a (stationary) PC, the network information server will instruct it to use Wi-Fi because most of the time this PC will not move. On the other hand, a mobile phone will be instructed to use a cellular network because of its higher potential for mobility. Examples for both device-controlled and network-controlled access choices are provided. The Device Mobility Class may be communicated at different stages of the device access.

Having the “Device Mobility Class” known at the network discovery and selection stage (for example, as a GAS and ANQP attribute) may be useful in the network selection decision. In a network-controlled access providing both cellular and WiFi accesses, the information is used as part of the network selection parameters. As an example, in a 3GPP network, using an access network discovery and selection function (ANDSF) field, the device declares its Device Mobility Class as a PC, the ANDSF uses this information to favor the device connection to a network with less mobility support, such as the WiFi network. A “Device Mobility Class” set to Mobile Phone, on the other hand, is favored to connect to a cellular network. Depending on the entity that controls the access, the device may be directed or forced to choose a specific network depending on its mobility class.

Having the “Device Mobility Class” known at the authentication phase (e.g., parameter sent with authentication request) may not help in network selection, but still may be used for subsequent actions. As an example, the information may be used for authorization purposes.

In a homogenous network (for example, WiFi only), different APs may provide different mobility support (such as fast transition). Some WiFi networks are integrated with cellular networks, so knowing the “Device Mobility Class” may still be useful in choosing between different WiFi networks. A highly mobile device may favor connection to a WiFi network that supports higher mobility (i.e., the one integrated with cellular).

A “Device Mobility Class” that is only known after connection may also be used for setting accounting differently. A “Device Mobility Class” that is only known after connection may also be used as follows: A control entity that determines the need for moving a mobile device based on the evaluation of several conditions such as quality of service (QoS), network load, mobility history, and the like, may also consider the Device Mobility Class as a factor in choosing the target network.

In alternative example embodiments, device capability classes or mobility classes also may be pre-provisioned, such that the station does not have to transmit the classes (device capability classes or mobility classes). In some example embodiments, the new attributes “Device Capability Class” and/or “Device Mobility Class” are defined, while in other example embodiments, attributes different from but related to these attributes are defined. These different attributes then are used to deduce the device capability class or mobility class. In still further embodiments, device capability classes and/or mobility classes are deduced using a behavior history of a station.

In an example embodiment, ANQP attributes (or the other formats and/or messages discussed above) are extended to include “Device Capability Class” and/or “Device Mobility Class.” The above-described methods and structures are applicable to advertisement protocols listed in table 8-175 in IEEE 802.11REVmb_D12.0 (FIG. 8), such as MIH information Service, MIH Command and Event Services Capability Discovery, and Emergency Alarm System.

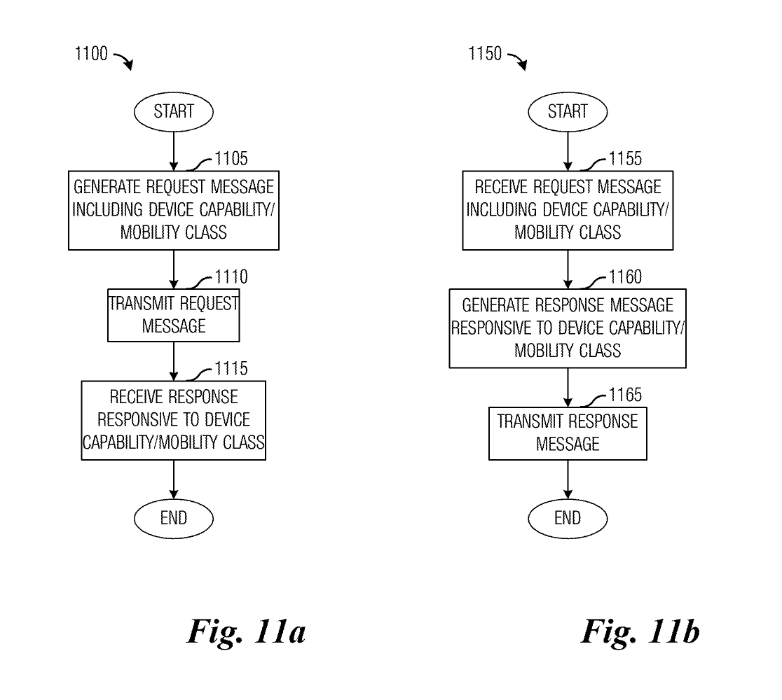

FIG. 11a illustrates a flow diagram of example operations 1100 occurring in a requesting device as the requesting device requests information using a request with a device capability and/or mobility class. Operations 1100 may be indicative of operations occurring in a requesting device, such as a requesting station 205 and requesting station 305, as the requesting device requests information using a request with a device capability and/or mobility class.

Operations 1100 may begin with the requesting device generating a request message including a device capability and/or mobility class(es) (block 1105). The device capability and/or mobility class(es) may include information regarding capabilities of the device (e.g., screen size, processing capability, resolution, radio access technologies, supported bands, preferred bands, and the like) and/or mobility of the device (e.g., potential for mobility, capability for mobility, amount of mobility, and the like). The request message may be a GAS message. The requesting device may transmit the request message (block 1110). The requesting device may receive a response message including information responsive to the device capability and/or mobility class(es) (block 1115). The response message may be from a responding device, such as an AP. The response message may include information from the AP responsive to the capabilities of the device and/or mobility of the device. The response message may include information from other APs, such as neighbor APs of the AP, responsive to the capabilities of the device and/or mobility of the device.

FIG. 11b illustrates a flow diagram of example operations 1150 occurring in a responding device as the responding device responds to a message with a device capability and/or mobility class. Operations 1150 may be indicative of operations occurring in a responding device, such as a responding station 210 and responding station 310, as the responding device responds to a message with a device capability and/or mobility class.

Operations 1150 may begin with the responding device receiving a message with device capability and/or mobility class(es) (block 1155). The responding device may determine a response to the device capability and/or mobility class(es). The responding device may determine an action or a response in accordance with the device capability and/or mobility class(es). As an illustrative example, if the device capability class specifies screen size, processing capability, resolution, and the like, the responding device may select a display resolution, an icon size, a text size, and the like, to meet information included in the device capability class(es). As another illustrative example, if the device mobility class specifies that the requesting device is a relatively immobile desktop personal computer, the responding device may select a WiFi connection for the requesting device. Similarly, if the device mobility class specifies that the requesting device is a rapidly moving cellular device, the responding device may select a cellular connection for the requesting device. Furthermore, if the responding station is not capable of responding to the message, the responding station may request responses from other APs, e.g., the responding device's neighbor APs. The responding device may generate a response message including its responses to the device capability and/or mobility class(es) or other APs response (block 1160). The responding device may transmit the response message (block 1165).

Knowledge of which service classes or services are supported by an AP and/or service provider can be a significant factor in making the decision for initial association and for handover; therefore an embodiment makes this information available prior or after association. An example embodiment enables service based queries and per realm service based query to help devices make a decision in initial association and for handing over.

An example embodiment includes an ANQP query about neighboring APs. In an example embodiment method, a station combines various ANQP attributes and their expected values via logical operators in a single query. The receiving AP replies to this query with a list of neighboring APs that satisfy the logical condition.

In an example embodiment, a mobile device may use the supported service information as a factor in network selection. Embodiments may be applied to Wi-Fi stations and servers, WiFi mobile devices supporting hotspot 2.0, and ANQP servers.

An example embodiment extends the ANQP attributes to include a “Service” extension, which are indicates supported by the hotspot (HS) or requested by the device and/or user.

An example embodiment enables querying per service, i.e., for the mobile device to send a query with a requested service. The receiving AP may respond depending on whether it supports that service or not. The query may be sent to an ANQP server that can provide information specific to the queried AP and/or information related to other neighboring APs.

An example embodiment enables querying for supported services, i.e., for the mobile device to send a query to an AP asking which services are supported. The receiving AP may respond by sending a list of supported services. The query may be sent to an ANQP server, which can provide information specific to the queried AP and/or information related to other neighboring APs.

An example embodiment enables querying using a combination of services and services with other elements such as Realm.

In an example embodiment, the mobile station sends an ANQP query asking for support of one or more services. If the receiving AP does not support the services, it may reply with the information of neighbor AP(s) that support the services. The AP may forward the ANQP query to an ANQP server, and the ANQP server feeds back to the AP the information about which neighbor APs support the services. Then the AP responds to the mobile station with the information about the neighbor APs that can support the services.

In an example embodiment, the mobile station may send an ANQP query asking for support of one or more services. The receiving AP also may reply with information of the neighbor AP(s) information that support the services. The AP may forward the ANQP query to an ANQP server, and the ANQP server feeds back to the AP the information about which neighbor APs support the services. Then the AP responds to the mobile station with the information about the neighbor APs that can support the services.

An example embodiment helps expedite the process of initial network discovery and the efficiency of handover process, where time generally is an essential factor in preserving the integrity of the connection and the user's experience.

The information about services may be locally available at the AP or may be obtained through an ANQP server or other APs. Although ANQP procedures are used for WiFi network discovery and selection, verifying Services before handover may be applicable to other entities such as BSs.

The above-described methods and structures are applicable to advertisement protocols listed in table 8-175 in IEEE 802.11REVmb_D12.0 (FIG. 8), such as MIH information Service, MIH Command and Event Services Capability Discovery, and Emergency Alarm System.

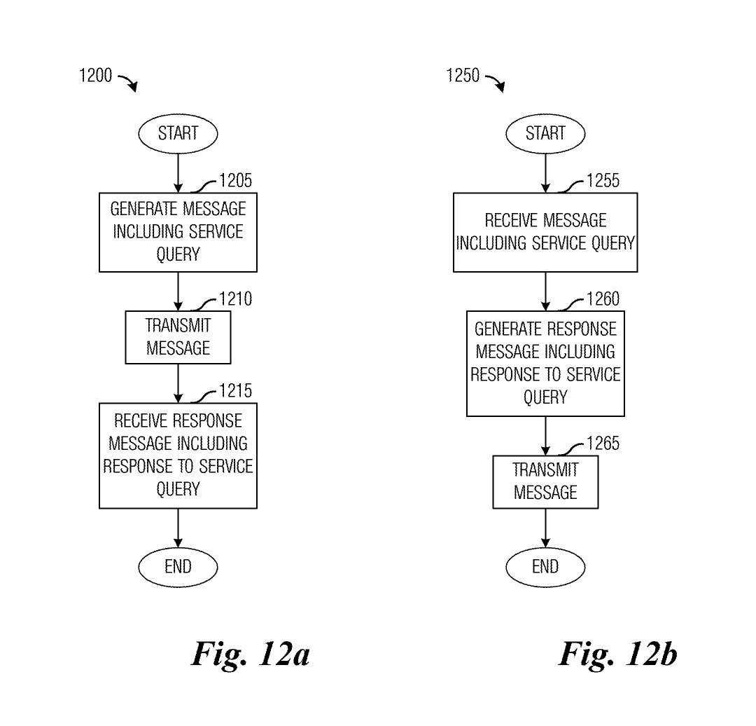

FIG. 12a illustrates a flow diagram of example operations 1200 occurring in a requesting device as the requesting device requests information about a service. Operations 1200 may be indicative of operations occurring in a requesting device, such as a requesting station 205 and requesting station 305, as the requesting device requests information about a service.

Operations 1200 may begin with the requesting device generating a request message including a request for a service (block 1205). The request for the service may specify a specific service or it may be a request for supported services. The request for service may combine the service request with geo-location information. The request for the service may specify a specific service for a realm or it may be a request for supported services for a realm, where a realm specifies a region or domain. The request for the service may specify a specific service for a realm within a location or it may be a request for supported services for a realm within a location, where a location specifies a geographical location. The request message may be a GAS message that includes ANQP class(es) indicating the service request, as well as the geo-location information. The requesting device may transmit the request message (block 1210).

The requesting device may receive a response message including information responsive to the request for the service (block 1215). The response message may be from a responding device, such as an AP. The response message may include information from the responding device responsive to the request for the service, such as whether or not the responding device provides the service, a list of services provided by the responding device, whether or not the responding device provides the service for the realm, a list of services provided by the responding device for the realm, whether or not the responding device provides the service for the realm within the location, a list of services provided by the responding device for the realm within the location, and the like. The response message may include information from other APs, such as neighbor APs of the responding device, responsive to the request for the service. The GAS response message including the ANQP class(es) may include a web site address, which could provide the requested services or where the user should be redirected. The station receiving such information may use the information to redirect the browser from an application to the web address indicated. At the indicated web address either some services are provided or the links to the service providers.

According to an alternative example embodiment, the AP provides another type of address (not the web address) where the user requesting a service could be redirected to access the requested services.

The responder AP may also provide cost information for requested services (for example, total cost, cost per hour, per unit of services, currency, and the like).

FIG. 12b illustrates a flow diagram of example operations 1250 occurring in a responding device as the responding device responds to a message with a request for a service. Operations 1250 may be indicative of operations occurring in a responding device, such as a responding station 210 and responding station 310, as the responding device responds to a message with a request for a service.

Operations 1250 may begin with the responding device receiving a message with a request for a service (block 1255). The responding device may determine if it meets the request for the service. As an illustrative example, the request may provide a service(s) and the responding device may determine if it provides the service. As another illustrative example, the request may request a list of services provided by the responding device and the responding device may determine a list of services that it provides. As yet another illustrative example, the request may request the service(s) and/or the list of services in conjunction with geo-locational information, such as realm and/or location. The responding device may forward the request for the service to other APs, such as its neighbor APs, for example. The responding device may generate a response message (block 1260). The response message may include information regarding the request for the service as provided by the responding device and/or information provided by the other APs. The responding device may transmit the response message (block 1265). The response message may be a GAS message that includes the information provided by the responding device and/or the other APs.

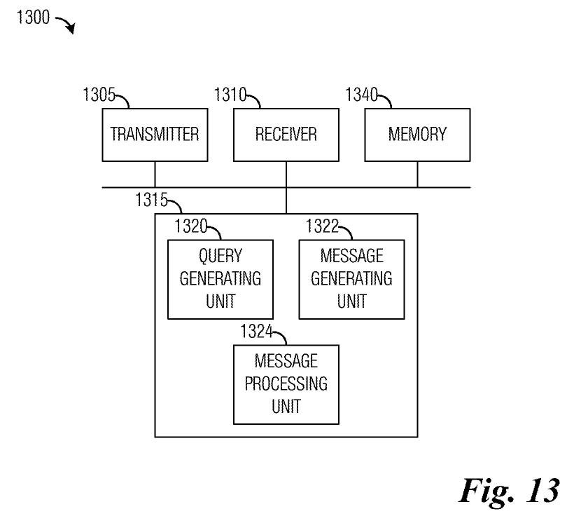

FIG. 13 illustrates an example communications device 1300. Communications device 1300 may be an implementation of a requesting device, such as a UE, a user, a subscriber, a terminal, a mobile, a mobile station, and the like, or a responding device, such as an AP, an eNB, a NodeB, a base station, an AN, and the like. Communications device 1300 may be used to implement various ones of the embodiments discussed herein. As shown in FIG. 13, a transmitter 1305 is configured to transmit frames, request messages, response messages, and the like. Communications device 1300 also includes a receiver 1310 that is configured to receive frames, response messages, request messages, and the like.

A query generating unit 1320 is configured to a query with device class information. Query generating unit 1320 is configured to generate a query including attribute class(es), device capability class(es), device mobility class(es), and the like. Query generating unit 1320 is configured to generate a query for a service. A message generating unit 1322 is configured to generate a message, such as a request message, a response message, and the like. A message processing unit 1324 is configured to process a received message, such as a request message, a response message, and the like. A memory 1340 is configured to store queries, classes, services, request messages, response messages, information from messages, information for messages, information from other APs, and the like.

The elements of communications device 1300 may be implemented as specific hardware logic blocks. In an alternative, the elements of communications device 1300 may be implemented as software executing in a processor, controller, application specific integrated circuit, or so on. In yet another alternative, the elements of communications device 1300 may be implemented as a combination of software and/or hardware.

As an example, receiver 1310 and transmitter 1305 may be implemented as a specific hardware block, while query generating unit 1320, message generating unit 1322, and message processing unit 1324 may be software modules executing in a microprocessor (such as processor 1315) or a custom circuit or a custom compiled logic array of a field programmable logic array. Query generating unit 1320, message generating unit 1322, and message processing unit 1324 may be modules stored in memory 1340.

Although the present disclosure and its advantages have been described in detail, it should be understood that various changes, substitutions and alterations can be made herein without departing from the spirit and scope of the disclosure as defined by the appended claims.

What is claimed is:

1. A method for operating a requesting station, the method comprising:
generating, by the requesting station, a generic advertising service (GAS) request message including device class information;
transmitting, by the requesting station, the GAS request message; and
receiving, by the requesting station, a GAS response message from a responding station, where the GAS response message includes information responsive to the device class information.

2. The method of claim 1, wherein the device class information comprises access network query protocol (ANQP) information.

3. The method of claim 2, wherein the ANQP information comprises information associated with an ANQP attribute class.

4. The method of claim 2, wherein the ANQP information comprises information associated with an ANQP access point (AP) class.

5. The method of claim 2, wherein the ANQP information comprises information associated with an ANQP attribute class, an ANQP AP class, an ANQP service, and an ANQP location.

6. The method of claim 2, wherein the ANQP information comprises an ANQP service class indicating service information requested by the requesting station.

7. The method of claim 6, wherein the service information comprises a service request, and wherein the information responsive to the ANQP service class comprises an indication that the service is supported by at least one of the responding station and at least one other device.

8. The method of claim 6, wherein the service information comprises a request for supported services, and wherein the information responsive to the ANQP service class comprises a list of services supported by at least one of the responding station and at least one other device.

9. The method of claim 6, wherein the GAS request message further includes realm information.

10. The method of claim 6, wherein the GAS request message further includes realm information within a specified location.

11. The method of claim 1, wherein the device class information comprises information associated with a device capability class of the requesting station.

12. The method of claim 1, wherein the device class information comprises information associated with a device mobility class of the requesting station.

13. The method of claim 1, wherein the information responsive to the device class information comprises information from the responding station.

14. The method of claim 1, wherein the information responsive to the device class information comprises information queried from at least one other device.

15. The method of claim 14, wherein the at least one other device comprises one of a neighbor AP, and a server.

16. A method for operating a responding station, the method comprising:
receiving, by the responding station, a generic advertising service (GAS) request message including device class information;
generating, by the responding station, a GAS response message including information responsive to the device class information; and
transmitting, by the responding station, the GAS response message.

17. The method of claim 16, wherein the information responsive to the device class information is derived from information regarding the responding station.

18. The method of claim 16, wherein the information responsive to the device class information is derived from information received from at least one other device queried by the responding station.

19. A requesting station comprising:
a processor configured to generate a generic advertising service (GAS) request message including device class information;
a transmitter operatively coupled to the processor, the transmitter configured to transmit the GAS request message; and
a receiver operatively coupled to the processor, the receiver configured to receive a GAS response message from a responding station, where the GAS response message includes information responsive to the device class information.

20. The requesting station of claim 19, wherein the device class information comprises access network query protocol (ANQP) information.

21. The requesting station of claim 20, wherein the ANQP information comprises information associated with an ANQP attribute class.

22. The requesting station of claim 20, wherein the ANQP information comprises information associated with an ANQP access point (AP) class.

23. A responding station comprising:
a receiver configured to receive a generic advertising service (GAS) request message including device class information;
a processor operatively coupled to the receiver, the processor configured to generate a GAS response message including information responsive to the device class information; and
a transmitter operatively coupled to the processor, the transmitter configured to transmit the GAS response message.

24. The responding station of claim 23, wherein the information responsive to the device class information is derived from information regarding the responding station.

25. The responding station of claim 23, wherein the information responsive to the device class information is derived from information received from at least one other device queried by the responding station.
